(19) United States
(12) Patent Application Publication
(10) Pub. No.: US 2004/0082229 A1
(43) Pub. Date: Apr. 29, 2004

(54) Elastic connection terminal

(75) Inventors: Pierre Bouley, Dijon (FR); Guy Eschermann, Chevigny-Saint-Sauveur (FR)

Correspondence Address: PARKHURST & WENDEL, L.L.P., 1421 PRINCE STREET, SUITE 210, ALEXANDRIA, VA, 22314-2805, US

(73) Assignee: SCHNEIDER ELEC. INDUSTRIES SAS, Rueil-Malmaison (FR)

(21) Appl. No.: 10/686,253

(22) Filed: Oct. 16, 2003

(30) Foreign Application Priority Data
Oct. 17, 2002 (FR) 02 13127

(51) Int. Cl. H01R 4/48

(52) U.S. Cl. 439/834

(57) ABSTRACT

Elastic connection terminal for an electric switch or junction device, comprising an elastic loop placed on a conducting part and an auxiliary part capable of forming a stop for the end of the cable.

The assembly and behaviour of the terminal are improved by placing an auxiliary part 30 in contact with the back of the support strip 18 of the conducting part 14. The part 30 is provided with at least on attachment element, for example a lug 34, engaged with the connection region of the support strip, and guide panels for the cable. The guide panels extend close to the connection area and they have a slope adapted to the curved shape of the loop 20 so as to guide it.

### DESCRIPTION

This invention relates to an elastic connection terminal for an electric switch or junction device, the terminal comprising a conducting part provided with a pressure strip at one end for an elastic loop that will clamp at least one cable.

In this type of terminal, an elastic loop is usually provided with a fitting arm, a clamping arm and a bent part connecting the fitting arm and the clamping arm. The fitting arm is applied on the front of the support strip to come into contact with the conducting part, while the clamping arm is provided with a window arranged to trap a cable inserted through an opening in a casing or a cover of the switch or junction device. More precisely, the cable is trapped between a moving edge of the window and a connection region on the back of the support strip; the cable is released by applying pressure on the bent part of the loop using a tool or an interconnection pin.

This type of terminal is described in document EP 1 052 729, and comprises an auxiliary part that limits bending of the loop and that can form a stop for the cable. The cable is inserted into this terminal using a guide that could be improved. Furthermore, cable forces during insertion cause the auxiliary part to float, and there is even risks of breaking it.

The purpose of the invention is to improve the guidance, support and insulation of the cable for this type of terminal, while maintaining satisfactory behaviour of the elastic loop and good cohesion of its assembled component parts.

According to the invention, the auxiliary part is brought into contact with the back of the support strip and is provided with at least one attachment element gripping the support strip, for example in its connection region. The result is good behaviour of the terminal in the switch or junction device, particularly under the effect of forces or shocks applied during manoeuvres of the cable and the tool.

The auxiliary part preferably has cable guide and insulation panels extending as far as the connection region for the conducting part and they are provided with a guide slope adapted to the curved shape of the loop clamping arm. The attachment elements may be lugs provided at the ends of guide panels located close to the clamping arm of the elastic loop.

The conducting part can advantageously be provided with a slit and the bottom of the auxiliary part may be provided with a tongue, the tongue passing through the slit to project on the front side of the support strip. The tongue thus defines a holding strip or a stop strip to limit sliding of the loop. The tongue may also be provided with a click fit or similar element that helps to hold the auxiliary part assembled to the conducting part.

An independent part for protection of the auxiliary part may advantageously be housed in the loop, being arranged in a manner known in itself to limit bending of the loop.

The following detailed description refers to an embodiment of the invention given as a non-limitative example and represented by the attached drawings.

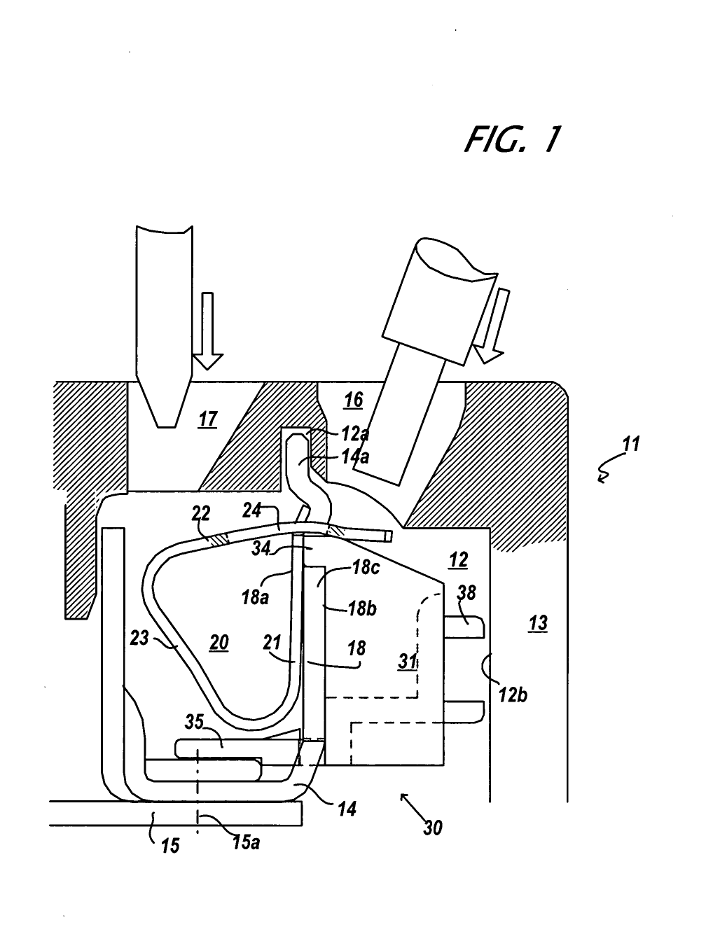

FIG. 1 diagrammatically shows a side view of a terminal according to the invention.

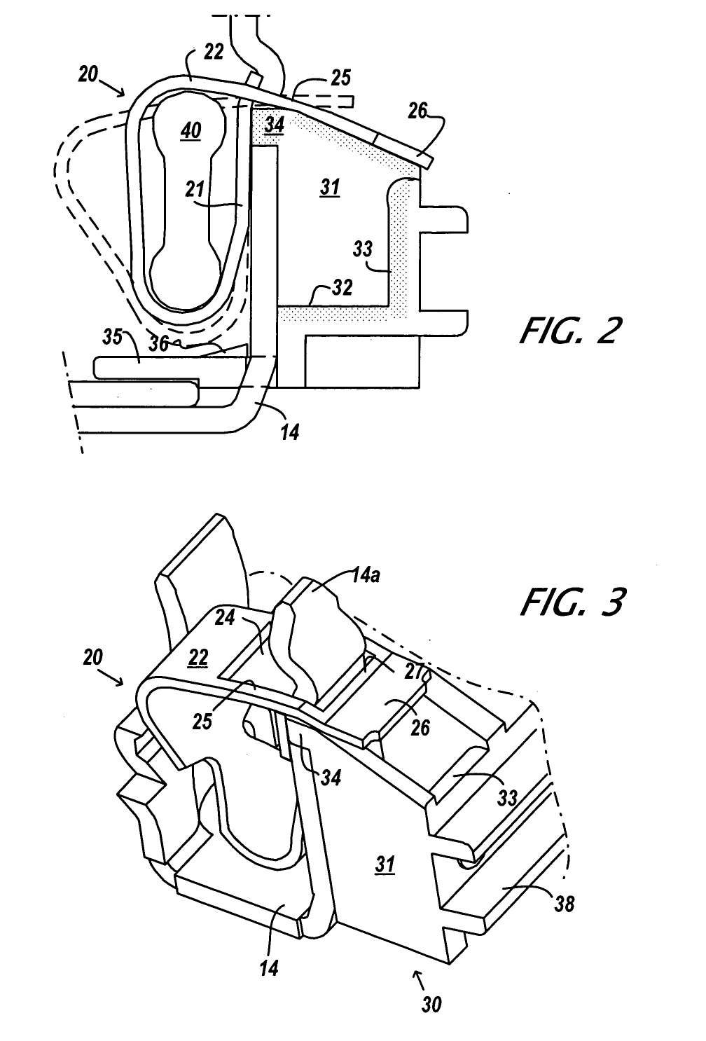

FIG. 2 shows a similar view of the elastic loop in the unclamped position.

FIG. 3 shows a perspective front view of the terminal according to the invention.

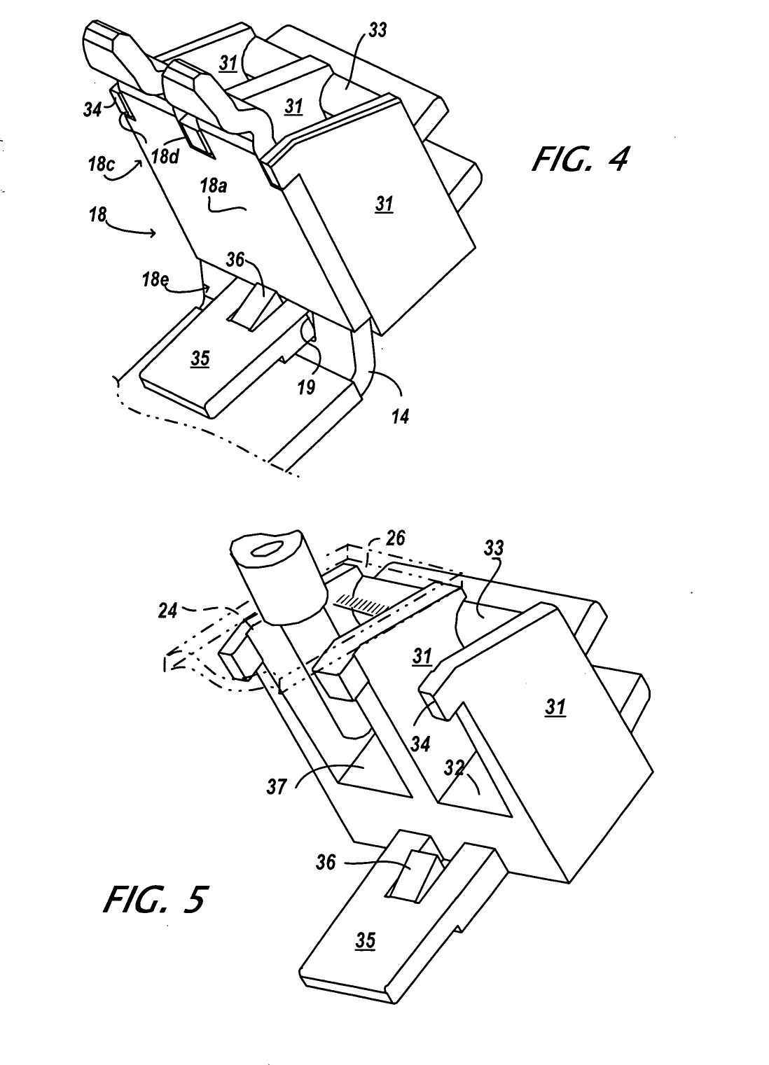

FIG. 4 shows a partial rear perspective view of a double terminal, similar to the terminal in FIG. 3.

FIG. 5 shows a perspective view of the auxiliary part of the terminal in FIG. 4.

The elastic connection terminal 10 illustrated in the figures is associated with or included in an electric switch or junction device 11 such as a contactor, circuit breaker, junction block, terminal block or other analogue electrical device facilitating fast connection. The terminal 10 is placed in an appropriate compartment 12 in the switch body or housing 13.

The terminal comprises a known type of elastic loop 20 installed on a conducting part 14 specific to the switch or junction device 11, for example the conducting part being inserted in or fixed in the housing 13 of the switch or junction device. In this case, the part 14 is fixed to a connection strip 15 by a screw 15a (illustrated by its centre-line in FIG. 1), the part 14 and/or the strip 15 being fixed to the housing by any means. The compartment 12 communicates with the outside of the housing 13 through an opening 16 in the form of a funnel into which a conducting cable stripped at the end is inserted, and an opening 17 through which a releasing tool or a connection conducting pin can be inserted.

Loop 20 provides a fitting arm 21 and a clamping arm 22 connected to each other through a bent part 23. The loop 20 is placed on a fixed support strip 18 of the conducting part 14 that has a front side 18a and a back side 18b. In more detail, the fitting arm 21 is applied to the front 18a, while the clamping arm 22 is provided with a window 24 defined laterally by two segments 25, and near the free end of the arm 22, by an end tongue 26 so that a clamping stop 27 comes into place facing the back side 18b (see FIG. 3).

An auxiliary part 30, designed to perform cable guide, stop and insulation functions, is applied in contact with the back 18b of the support strip 18. The auxiliary part 30 has cable guide panels 31, a bottom stop 32 for the cable and a back wall 33. There are also lugs 34 or similar attachment elements near the top and projecting forwards that fit onto the conducting part 14, and near the bottom there is at least one tongue 35 that penetrates into a slit 19 of the part 18. The lugs and the tongue put the auxiliary part 30 into position and hold it on the part 14. The tongue 35 acts as a bottom stop for the elastic loop, and it is provided with a click fit element (or an insertion element) 36 that holds the part 30 assembled to the support strip 18. Stops 38 are provided at the back of the part 30 in the form of ribs or pins cooperating with a face 12b of the compartment 12. It can be seen that the panels 31 cooperate with the bottom 32 and the back wall 33 to form an individual compartment 37 for the stripped end of the cable, in particular for guidance functions and providing interphase insulation when several wires are connected in adjacent terminals for different phases (for example see FIGS. 4 and 5). This space also protects the electrical terminal against the harmful effects caused by the entry of polluting materials.

The panels 31 of the auxiliary part 30 are applied through plane faces onto the corresponding plane face of the back 18b of the part 14, close to the clamping arm 22 of the loop. They are provided with attachment or click fit elements just below this arm 22 (FIGS. 1-4). In this case, attachment lugs 34 are used that fit into notches 18d located near the top of the part 14 close to the end of the support strip 18 in its connection region 18c. Obviously, different shapes of cooperating elements with the same attachment or click fit function can be used instead of the lugs 34 and notches 18d. The panels 31 aligned with the lugs 34 have a special shape, for example with a downwards slope, adapted to the sloping or curved shape of the arm 22 and its pivoting movement, to facilitate its guidance. The tongue 35 is placed orthogonal to the direction in which the cable is inserted and passes through the slit 19 provided in the region 18e of the strip 18 opposite its connection region 18c (see FIG. 4).

The compartment 37 determined by the bottom 32, the panels 31 and the wall 33 guides the end of the cable after it projects out of the funnel, and helps to house the end of the cable. The insertion or click fit element 36 cooperates with the lugs 34 to provide a rigid and strong assembly of the auxiliary part 30 with the conducting part 14. A protection part 40, independent of the auxiliary part 30, is placed inside the loop to limit compression of the loop.

The terminal described is used as follows. A manoeuvring tool or pin is inserted in the opening 17 to press on the outside of the bent part 23 and thus put the elastic loop in the relaxed position (in solid lines on FIG. 2). As a result, the edges of the tongue 26 and the side segments 25 of the clamping arm 22 slide on the slopes of the guide panels 31. A cable, for example a multi-strand cable is then presented in front of the opening 16 and is inserted in it, the slope of the funnel bringing the stripped end of the cable into contact with the back 18b of the support strip 18 in its connection region 18c. The end of the cable is guided firstly by the back 18b of the strip 18, and secondly laterally by the panels 31, until it is stopped by the bottom 32. Note that the cable inserted in its compartment 37 remains insulated from a cable inserted in a compartment 37 adjacent to it by the intermediate panel 31 that forms a partition.

Thrust forces applied to the auxiliary part 30 when the cable is inserted are resisted at the top by the upper part (in the figures) of part 14 by means of the lugs 34 engaged in notches 18d and at the bottom by the tongue 35 cooperating with the slit 19. Tangential thrust forces applied to part 14 when the tool inserted in the opening 17 presses the part 23 of the loop 20 are resisted by the housing 13, firstly by means of a slit 12a that houses the end tongue 14a of part 14, and secondly by the front 12b of the compartment 12, into which the stops 38 of the part 30 come into contact.

1. Elastic connection terminal for an electric switch or junction device, said device comprising a conducting part (14) provided at one end with a support strip (18) with a connection region (18c), the terminal being fastened to the support strip and comprising:
an elastic loop (20) provided with a fitting arm (21), a cable clamping arm (22) and a bent part (23) connecting the fitting arm and the clamping arm, the fitting arm being applied on the front of the support strip (18) to come into contact with the conducting part (14), while the clamping arm is provided with a window arranged to clamp a cable between the back of the support strip and an edge of the window, and,
an auxiliary part (30) capable of forming a stop for one end of the cable inserted into the terminal,
wherein
the auxiliary part (30) is brought into contact with the back (18b) of the support strip (18) and is provided with at least one attachment element (34) gripping a region of the support strip (18) so as to be joined to the conducting part.

2. Terminal according to claim 1, wherein the auxiliary part (30) has cable guide panels (31), the panels extending as far as the connection region (18c) of the support strip and comprising attachment elements (34) near this connection region.

3. Terminal according to claim 2, wherein the auxiliary part (30) has a back wall (33) and that the guide panels (31) define an individual compartment (37) for each cable, with the support strip (18) and the back wall (33), this compartment being delimited by a panel (31) so that it can be isolated from the adjacent compartment (37).

4. Terminal according to claim 2, wherein the guide panels (31) are shaped to form a guide, and particularly a slope, adapted to the shape of the clamping arm and its pivoting movement.

5. Terminal according to claim 1, wherein the conducting part (14) is provided with a slit (19) and that the bottom of the auxiliary part (30) is provided with an assembly tongue that acts as a stop (35), the said tongue passing through the slit to project on the front side (18a) of the support strip (18).

6. Terminal according to claim 5, wherein the tongue (35) is provided with a click-fit or similar element (36) that helps to hold the auxiliary part (30) assembled to the conducting part (14).

7. Terminal according to claim 1, wherein a protective part (40) is housed in the loop and arranged to limit bending of the elastic loop, the protective part (40) being independent of the auxiliary part (30).

8. Terminal according to claim 1, wherein the auxiliary part (30) is provided with at least one stop (38) cooperating with a stop face (12b) of the housing in a direction corresponding to pressure being applied to the elastic loop by a manoeuvring tool or pin.
